(19) United States
(12) Patent Application Publication
(10) Pub. No.: US 2013/0095257 A1
(43) Pub. Date: Apr. 18, 2013

(54) SURFACTANT COMPOSITION, COATING SOLUTION CONTAINING THE SURFACTANT COMPOSITION, AND RUBBER ARTICLE TREATED BY THE COATING SOLUTION

(71) Applicants: NISSIN CHEMICAL INDUSTRY CO., LTD., Echizen-shi (JP); SHIN-ETSU CHEMICAL CO., LTD., Tokyo (JP)

(72) Inventors: Toru MIZUSAKI, Echizen-shi (JP); Masayuki NAKANISHI, Echizen-shi (JP); Shoichi ARIMA, Echizen-shi (JP); Ichiro TANII, Echizen-shi (JP); Masahiko MINEMURA, Annaka-shi (JP); Ichiro ONO, Annaka-shi (JP)

(73) Assignees: SHIN-ETSU CHEMICAL CO., LTD., Tokyo (JP); NISSIN CHEMICAL INDUSTRY CO., LTD., Echizen-shi (JP)

(21) Appl. No.: 13/650,500

(22) Filed: Oct. 12, 2012

(30) Foreign Application Priority Data
Oct. 14, 2011 (JP) 2011-226491

(51) Int. Cl. C09D 171/08; C08K 5/06; C09D 175/04; A41D 19/00; B32B 25/08; B32B 1/02; B32B 1/08; A41D 19/015; C08K 5/5419; B05D 7/02

(52) U.S. Cl. 428/12; 524/265; 106/287.13; 427/387; 428/447; 428/36.8; 428/337; 2/161.7; 2/161.6; 2/159

(57) ABSTRACT

A surfactant composition is provided. The composition comprises (A) an acetylenediol ethoxylate capped by a glycidyl ether represented by the following structural formula (I):

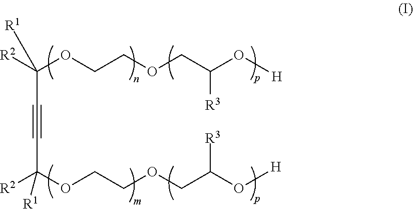

wherein R¹ is hydrogen atom, or a C₁₋₆ straight chain, branched or cyclic alkyl group, R² is a C₁₋₁₂ straight chain, branched or cyclic alkyl group, R³ is —CH₂OR⁴, R⁴ is a C₂₋₃₀ straight chain, branched or cyclic alkyl group, alkenyl group, aryl group, or aralkyl group, n, m, p, and q are a positive number with the average of (n+m) being 1 to 100, and the average of (p+q) being 0.5 to 5), and (B) a silicone surfactant. The coating solution prepared by blending the surfactant composition of the present invention can be coated without causing inconsistency since it does not experience foaming when coated on the rubber article, and industrially advantageous production of a rubber article with non-sticky surface is thereby enabled.

### CROSS-REFERENCE TO RELATED APPLICATION

This non-provisional application claims priority under 35 U.S.C. §119(a) on Patent Application No. 2011-226491 filed in Japan on Oct. 14, 2011, the entire contents of which are hereby incorporated by reference.

### TECHNICAL FIELD

This invention relates to a surfactant composition, and more specifically, to a surfactant composition which can be coated without foaming and without coating inconsistency. This invention also relates to a coating solution containing such surfactant composition and a rubber article prepared by coating the coating solution.

Various rubber articles are made from natural and synthetic rubbers. Exemplary such articles include surgical gloves, inspection gloves, work gloves, contraceptives, catheters, balloons, tubes, and sheet materials. This invention relates to coating of rubber articles, and the description is made by focusing on the coating of gloves which are the most complicated rubber articles in terms of their application and production, although the present invention does not be limited to gloves.

### BACKGROUND ART

Rubber gloves prepared from a natural rubber or a synthetic rubber have sticky surface, and the rubber glove often sticks to hands and fingers as well as to other parts of the rubber glove. Accordingly, handling of rubber gloves has been quite difficult, and various countermeasures have been taken to facilitate putting on and off, namely, wearability of the rubber gloves, for example, by sprinkling a powder such as talc or mica or by providing surface irregularity on the inner surface of the glove by chlorination. For example, JP-A S61-24418 discloses a rubber glove having an inner surface prepared from a synthetic resin latex containing a powder such as talc, calcium carbonate, mica, or starch. However, the glove obtained by such method had the problem that the powder came off the glove in the wearing and during use of the gloves, and use of such gloves for surgical purpose was associated with the risk of postoperative infection by the contamination of the operated lesion by the powder which had come off the gloves. The chlorine treatment had difficulty in the process control, and improvement in the wearability was insufficient. Use of chlorine also had the problem of high environmental stress.

JP-A H06-340758 proposes a method comprising coating a rubber latex containing a polymer flocculant on the rubber glove, drying the coated surface, washing the surface with water, and roughening the surface. This process, however, suffers from complicated production process.

Instead of these methods, attempts have also been made to improve the glove wearability by forming a layer containing a lubricant on the inner surface of the glove. For example, JP-B S60-6655 discloses a medical glove having formed therein a layer prepared from a carboxylated styrene-butadiene latex having starch dispersed therein, and JP-A H11-61527 discloses a rubber glove having a lubricating resin layer formed by using an aqueous dispersion containing a synthetic rubber latex which does not coagulate by the coagulant in the glove itself and an organic filler such as crosslinked polymethylmethacrylate. Improvements in the glove wearability by these methods, however, were still insufficient.

JP-B H05-13170 proposes a hydrogel coating method wherein a hydrogel polymer which is a copolymer of 2-hydroxyethylmethacrylate and methacrylic acid and/or 2-ethylhexyl acrylate is coated with a curing agent and the hydrogel is bonded to the rubber film by thermal curing. In this method, the hydrogel is coated after treating the rubber film surface with an acid or alkali in order to improve bonding between the rubber film and the hydrogel film and the coated hydrogel is cured by using a curing agent. This process is complicated, and the use of the acid or alkali requires the acid- or alkali-removal step.

In order to improve stickiness of the outer surface, sprinkling of a fine powder such as talc or mica on the outer surface and chlorine treatment wherein the glove is dipped in chlorine water for reaction of the outer surface with the chlorine to form a partly cured surface have been conducted. However, these powder treatment and chlorine treatment are quite complicated, and in commercial production, this results in the increased cost.

An acetylenediol ethoxylate capped by glycidyl ether is disclosed in JP-A 2003-238472. However, its use for rubber articles is not disclosed.

### SUMMARY OF INVENTION

An object of the present invention is to provide a surfactant composition which is blended in a coating solution that enables industrially advantageous production of a rubber article having a non-sticky surface. Another object of the present invention is to provide a coating solution and a rubber article.

The inventors of the present invention made an intensive study in order to realize the objects as described above, and developed a surfactant composition comprising (A) a glycidyl ether-capped acetylenediol ethoxylate and (B) a silicone surfactant, which can be used in a solution for coating a rubber article.

Accordingly, the present invention provides a surfactant composition comprising

(A) an acetylenediol ethoxylate capped by a glycidyl ether represented by the following structural formula (I):

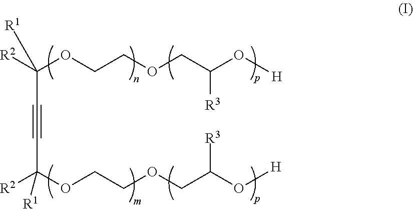

wherein R¹ is hydrogen atom, or a straight chain, branched or cyclic alkyl group containing 1 to 6 carbon atoms, R² is a straight chain, branched or cyclic alkyl group containing 1 to 12 carbon atoms, R³ is —CH₂OR⁴, R⁴ is a straight chain, branched or cyclic alkyl group, alkenyl group, aryl group, or aralkyl group containing 2 to 30 carbon atoms, n, m, p, and q are independently a positive number with the average of (n+m) being 1 to 100, and the average of (p+q) being 0.5 to 5, and

(B) a silicone surfactant.

The surfactant composition is preferably used as a coating composition for a rubber article.

In this case, the surfactant composition comprises 5 to 80% by weight of component (A) and 20 to 95% by weight of component (B).

Preferably, the glycidyl ether of the component (A) is at least one member selected from 2-ethylhexyl glycidyl ether and lauryl glycidyl ether. The silicone surfactant of the component (B) is preferably a nonionic silicone surfactant such as a polyoxyalkylene-modified silicone.

The polyoxyalkylene-modified silicone is preferably represented by the following average compositional formula (II):

R⁵ₓR⁶_{y}SiO_{(4-x-y)/2} (II)

wherein R⁵ is a substituted or unsubstituted monovalent hydrocarbon group containing 1 to 10 carbon atoms and having no aliphatic unsaturated bond; R⁶ is an organic group represented by —C_{f}H_{2f}O(C_{g}H_{2g}Oₕ)R⁷ wherein R⁷ is hydrogen atom, a substituted or unsubstituted monovalent hydrocarbon group having no aliphatic unsaturated group, or an acetyl group, f is an integer of 2 to 12, g is an integer of 2 to 4, and h is an integer of 1 to 200; and x and y are independently a positive number satisfying 0≦x<3.0, 0<y<3.0, and 0<x+y≦3.0.

The content of the polyoxyethylene in the polyoxyalkylene-modified silicone is preferably in the range of 30 to 80% by weight.

The surfactant composition may further comprises

(C) an ion exchanged water or a water-soluble organic solvent at an amount of up to 90 parts by weight in relation to 100 parts by weight of the total of the component (A) and the component (B).

The present invention also provides a coating solution containing the surfactant composition and a synthetic resin.

The synthetic resin preferably has a weight average molecular weight in terms of polystyrene as measured by gel permeation chromatography (GPC) of 2,000 to 500,000, and is at least one selected from the group consisting of polyvinyl alcohol, oxidized starch, etherified starch, carboxymethylcellulose, hydroxyethylcellulose, casein, gelatin, soy protein, silanol-modified polyvinyl alcohol, latex of styrene-butadiene copolymer and methylmethacrylate-butadiene copolymer, latex of acrylate and methacrylate copolymer, maleic anhydride resin, melamine resin, urea resin, polymethylmethacrylate, polyurethane, unsaturated polyester, polyvinylbutyral, and alkyd resin.

The coating solution may have a static surface tension of 20 to 32 mN/m.

The present invention further provides a rubber article having a coating film formed by using the above coating solution.

The present invention further provides a rubber article which is used as a home, toy, sport or farm implement.

The present invention further provides a rubber article which is a surgical glove, inspection glove, work glove, contraceptive, catheter, balloon, tube or sheet.

The present invention further provides a rubber article wherein a thickness of the rubber obtained from the coating solution of claim 10 is 0.5 to 300 μm at the dry state.

The present invention also provides a method of preparing a rubber article comprising applying the above coating solution to a rubber selected from the group consisting of nitrile rubber, chloroprene rubber, ethylene propylene rubber, butyl rubber, urethane rubber, styrene butadiene rubber, butadiene rubber, isoprene rubber, acrylic rubber, carboxy-modified acrylic rubber, fluororubber, and silicone rubber, and drying the coating solution at normal temperature to 150° C. for 0.5 to 5 minutes to form a film having a thickness of 0.5 to 300 μm at the dry state.

### ADVANTAGEOUS EFFECTS OF INVENTION

The coating solution prepared by blending the surfactant composition of the present invention can be coated without inconsistency since it does not experience foaming when coated on the rubber article, and industrially advantageous production of a rubber article with non-sticky surface is thereby enabled.

### DESCRIPTION OF EMBODIMENTS

The surfactant composition of the present invention contains a glycidyl ether-capped acetylenediol ethoxylate (A) and a silicone surfactant (B).

The glycidyl ether-capped acetylenediol ethoxylate (component (A)) means that the OH terminal of the acetylenediol ethoxylate is bonded to the epoxy group moiety of the glycidyl ether, and the acetylenediol ethoxylate of the component (A) is the one represented by the following structural formula (I):

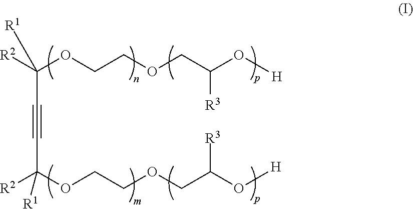

wherein R¹ is hydrogen atom, or a straight chain, branched or cyclic alkyl group containing 1 to 6 carbon atoms and preferably 3 to 5 carbon atoms, R² is a straight chain, branched or cyclic alkyl group containing 1 to 12 carbon atoms, and preferably 1 to 5 carbon atoms, R³ is —CH₂OR⁴, R⁴ is a straight chain, branched or cyclic alkyl group, alkenyl group, aryl group, or aralkyl group containing 2 to 30 carbon atoms, and preferably 2 to 10 carbon atoms, and n, m, p, and q are independently a positive number with the average of (n+m) being 1 to 100, preferably 3 to 30, and more preferably 8 to 20, and the average of (p+q) being 0.5 to 5 and preferably 0.8 to 2.

In this case, the glycidyl ether is preferably the one represented by the following structural formulae:

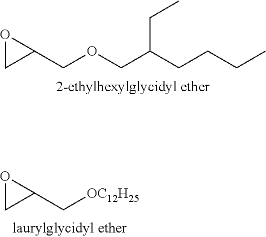

Examples of the acetylenediol ethoxylate capped by glycidyl ether (component (A)) include those described in JP-A 2003-238472.

The component (A) used for preparing the surfactant composition of the present invention is preferably used at an amount of 5 to 80% by weight, and more preferably at 7 to 60% by weight in 100% by weight of the total of the component (A) and the component (B) as described below. When used at an amount less than 5% by weight, bubbles may be formed in the coating, and this may result in the insufficient coating due to the coating failure such as inconsistent coating. Incorporation at an amount in excess of 80% by weight may result in poor wettability, and hence, in the coating failure.

The silicone surfactant of the component (B) is preferably a nonionic silicone surfactant. Preferable examples include polyoxyalkylene-modified silicones such as those represented by the following average compositional formula (II):

R⁵ₓR⁶_{y}SiO_{(4-x-y)/2} (II)

wherein R⁵ is a substituted or unsubstituted monovalent hydrocarbon group having no unsaturated bond and containing 1 to 10 carbon atoms, preferably 1 to 8 carbon atoms; R⁶ is an organic group represented by the general formula: —C_{f}H_{2f}O(C_{g}H_{2g}Oₕ)R⁷ wherein R⁷ is hydrogen atom, a substituted or unsubstituted monovalent hydrocarbon group containing no aliphatic unsaturated group such as alkyl group containing 1 to 8 carbon atoms, and in particular, 1 to 4 carbon atom, or an acetyl group, f is an integer of 2 to 12, and in particular, 2 to 6, g is an integer of 2 to 4, and h is an integer of 1 to 200, preferably 1 to 100, and more preferably 1 to 50; and x and y are independently a positive number satisfying 0≦x<3.0, 0<y<3.0, and 0<x+y≦3.0, and preferably, x is 0.1 to 2, y is 0.2 to 2, and x+y is 0.3 to 3.

Content of the polyoxyethylene in the polyoxyalkylene-modified silicone is preferably 30 to 80% by weight.

Non-limiting examples of the silicone surfactant include those represented by the following structural formulae (1) to (7):

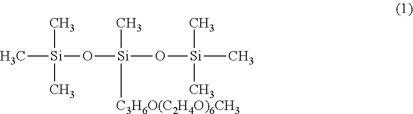

Polyoxyethylene content: 47.3% by weight

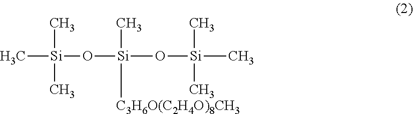

Polyoxyethylene content: 54.5% by weight

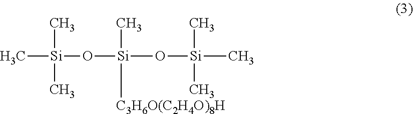

Polyoxyethylene content: 55.7% by weight

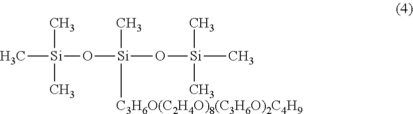

Polyoxyethylene content: 43.4% by weight

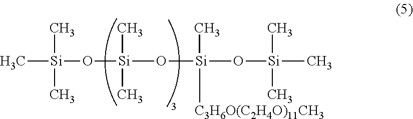

Polyoxyethylene content: 48.4% by weight

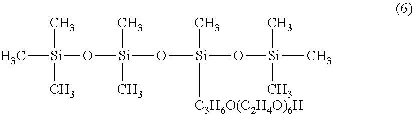

Polyoxyethylene content: 52.2% by weight

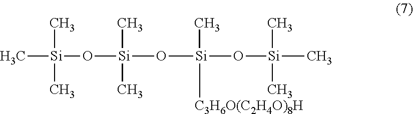

Polyoxyethylene content: 60.3% by weight

These silicone surfactants may be used alone or in combination of two or more.

The component (B) used in preparing the surfactant composition of the present invention is preferably used at an amount of 20 to 95% by weight, and more preferably at 40 to 93% by weight in 100% by weight of the total of the component (A) and the component (B). Use at an amount of less than 20% by weight may result in poor wettability, and hence, in the coating failure. When used at an amount in excess of 95% by weight, bubbles may be formed in the coating, and this may result in the insufficient coating due to the coating failure such as inconsistent coating.

The surfactant composition of the present invention preferably comprises the component (A) and the component (B) at the total content of 100% by weight. However, the surfactant composition of the present invention may also comprise a third component (C) which may be ion exchanged water or a water-soluble organic solvent such as ethylene glycol, diethylene glycol, triethylene glycol, tetraethylene glycol, polyethylene glycol, propylene glycol, 1,3-propanediol, 1,4-butanediol, or glycerin. The component (C) may be used at up to 90 parts by weight, preferably at up to 50 parts by weight, and more preferably at up to 30 parts by weight in relation to 100 parts by weight of the total of the component (A) and the component (B) as long as the merits of the present surfactant are not impaired.

When the ion exchanged water or the water soluble organic solvent is added, the amount is preferably at least 5 parts by weight, especially at least 20 parts by weight per 100 parts by weight of the total of the components (A) and (B).

The surfactant composition of the present invention may be obtained by mixing the components as described above by a known mixing method such as those using a propeller stirrer.

The coating solution of the present invention is prepared by blending the main resin component with the surfactant composition of the present invention. The surfactant composition may be blended so that the total of the component (A) and the component (B) is at 0.1 to 30 parts by weight per 100 parts by weight of the solid content of the main resin component. Use at less than 0.1 part by weight may result in the coating failure such as coating inconsistency due to insufficient wettability. On the other hand, use at an amount in excess of 30 parts by weight may result in the coating failure such as coating inconsistency due to insufficient solubility.

The resin which is the main component may be a natural or synthetic resin having a weight average molecular weight in terms of polystyrene as measured by gel permeation chromatography (GPC) of 2,000 to 500,000. Examples of such resin include polyvinyl alcohol, cellulose derivatives such as oxidized starch, etherified starch, carboxymethylcellulose, and hydroxyethylcellulose, casein, gelatin, soy protein, silanol-modified polyvinyl alcohol, latex of a conjugated diene such as styrene-butadiene copolymer and methylmethacrylate-butadiene copolymer, latex of an acryl copolymer such as acrylate and methacrylate copolymer, synthetic resins such as maleic anhydride resin, melamine resin, urea resin, polymethylmethacrylate, polyurethane, unsaturated polyester, polyvinylbutyral, and alkyd resin, which may be used alone or in combination of two or more and which is preferably in the form of an aqueous solution or an aqueous dispersion.

The coating solution of the present invention may further comprise an ion exchanged water, water-soluble organic solvent, filler, pH adjusting agent, antioxidant, antiseptic, curing agent, and the like. Exemplary fillers include silica, clay, and titanium oxide.

The coating solution of the present invention is preferably in the form of an aqueous solution, a solution in a water-soluble organic solvent, or a solution in a mixed solvent of water and a water-soluble organic solvent. The solid content is preferably at 0.5 to 10% by weight, and more preferably at 1 to 5% by weight. The coating solution of the present invention is obtained by mixing the components as described above by a known mixing method such as those using a propeller stirrer. In such case, the stirring is preferably conducted at a speed of at least 500 rpm, and more preferably 500 to 1,500 rpm.

The coating solution of the present invention is preferably adjusted to a static surface tension of 20 to 32 mN/m, and more preferably to 20 to 30 mN/m. The contact angle is preferably 5 to 55°, and more preferably 5 to 50°. Foaming is preferably up to 15 ml.

The coating solution is coated on the article to a thickness which depends on the type of the article. The coating solution is coated preferably to a thickness of about 0.5 to 300 μm, more preferably about 1 to 100 μm, and most preferably 5 to 50 μm at the dry state.

The coating may be accomplished by selecting a known method such as dipping, spray coating, roll coating, calendar coating, or spin coating. When dipping, the dipping time is 5 to 30 seconds.

If desired, the coated composition may be dried by heating to room temperature (15° C.) to 150° C., preferably 80 to 130° C., more preferably 100 to 120° C. for 0.5 to 5 minutes so that the coating of the composition is formed on the rubber.

Exemplary rubbers used for coating the coating solution of the present invention include, nitrile rubber, chloroprene rubber, ethylene propylene rubber, butyl rubber, urethane rubber, styrene butadiene rubber, butadiene rubber, isoprene rubber, acrylic rubber, carboxy-modified acrylic rubber, fluororubber, and silicone rubber, and the rubbers may be in various forms such as film, sheet, plate, spheres, and the like.

The method of preparing a rubber glove is as follows.

A metal mold having the shape (the glove shape) to be formed is immersed in coagulating agent slurry containing calcium nitrate and calcium carbonate. After drying, the metal mold thus treated is immersed in a rubber emulsion for such a sufficient time that the rubber is coagulated to form a coating layer having the desired thickness on the metal mold. The coagulated rubber layer is cured in an oven, cooled, and then immersed in the coating solution according to the present invention. The surface of the rubber layer coated with the coating solution is dried. After cooling, the rubber layer is taken off from the metal mold, and is turned inside out thereby obtaining a glove.

Alternatively, the coating solution is applied to a rubber sheet having a desired shape. Then, the rubber sheet having the layer of the coating solution applied is processed or molded to a rubber article.

The coating solution of the present invention is particularly effective for the manufacture of gloves for home, medical, and other applications. The coating solution of the present invention may also be effectively used for coating the desired portion of home, toy, sport, and farm implements and tools which are made from a rubber.

### EXAMPLES

Next, the present invention is described in further detail by referring to the following Preparation Examples, Examples, and Comparative Examples which by no means limit the scope of the present invention. In the following Preparation Examples, Examples, and Comparative Examples, parts and % are respectively parts by weight and % by weight.

### Preparation Examples

7.5 parts of acetylenediol ethoxylate capped by 2-ethylhexyl glycidyl ether which had been heated to 70° C. was placed in a container equipped with a propeller stirrer, and 92.5 parts of the silicone surfactant represented by the formula (7) was gradually added with stirring. After continuously stirring the mixture for 2 hours, the mixture was cooled to room temperature. After cooling, the mixture was filtered through a filter fabric (200 mesh) to obtain a surfactant composition (hereinafter referred to as M-1).

The procedure as described above was repeated by using the composition shown in Table 1 to obtain surfactant compositions M-2 to M-14.

TABLE 1

| (pbw) | M-1 | M-2 | M-3 | M-4 | M-5 | M-6 | M-7 | M-8 | M-9 | M-10 | M-11 | M-12 | M-13 | M-14 |
|---|---|---|---|---|---|---|---|---|---|---|---|---|---|---|
| A-1 | 7.5 | 15 | 55 | 7.5 | 15 | 55 | | | 100 | | | | 44 | |
| A-2 | | | | | | | | | | 20 | 50 | | | |
| A-3 | | | | | | | | | | | | 20 | | |
| A-4 | | | | | | | | | | | | | | 7.5 |
| B-1 | 92.5 | 85 | 45 | | | | 100 | | | 80 | 50 | 80 | | 92.5 |
| B-2 | | | | 92.5 | 85 | 45 | | 100 | | | | | 36 | |
| C-1 | | | | | | | | | | | | | 20 | |

*(pbw) = (parts by weight)
A-1: alkoxylene oxide addition product of 2-ethylhexyl glycidyl ether-capped 2,4,7,9-tetramethy1-5-decin-4,7-diol (represented by formula (I) with the average value of n + m of about 10 and the average value of p + q of about 2)
A-2: ethylene oxide addition product of 2,4,7,9-tetramethyl-5-decin-4,7-diol (molar amount of the ethylene oxide added: 3.5)
A-3: ethylene oxide addition product of 2,4,7,9-tetramethyl-5-decin-4,7-diol (molar amount of the ethylene oxide added: 10)
A-4: alcoxylene oxide addition product of lauryl glycidyl ether-capper 2,4,7,9-tetramethyl-5-decin-4,7-diol (represented by formula (I) with the average value of n + m of about 10 and the average value of p + q of about 2)
B-1: A silicone surfactant represented by formula (7): 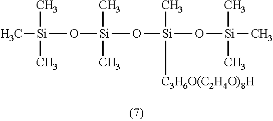
polyoxyethylene content: 60.3% by weight
B-2: A silicone surfactant represented by formula (4): 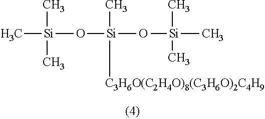
polyoxyethylene content: 43.4% by weight
C-1: ethyleneglycol

### Examples 1 to 10 and Comparative Examples 1 to 7

The surfactant composition, the polyurethane aqueous solution (solid content: 18% by weight; weight average molecular weight in terms of polystyrene measured by GPC: 10,000), and the ion exchanged water at the ratio shown in Tables 2 and 3 were placed in a container equipped with a propeller stirrer, and the mixture was stirred for 1 hour at 1,000 rpm. Physical properties were measured and the results are shown in Tables 2 and 3.

The measurement of the physical properties was conducted by the procedure as described below.

### Evaluation of the Coating Solution

### (1) Coating Conditions

The coating solution was coated on nitrile rubber (NBR), and the coating conditions were visually evaluated by the following criteria:
◯: no coating inconsistency
Δ: slight coating inconsistency
×: considerable coating consistency

### (2) Static Surface Tension

The static surface tension of the coating solution was measured by using surface tension meter ESB-V manufactured by Kyowa Interface Science Co., Ltd.

### (3) Contact Angle

The contact angle at 30 seconds after dropping the coating solution was measured by using contact angle meter CA-D manufactured by Kyowa Interface Science Co., Ltd.

### (4) Foaming Property

20 ml of the coating solution was placed in a 100 ml measuring cylinder, and shaken by using a shaker (180 cycles/min). Amount (in ml) of the foam was measured immediately after stopping the shaking and after 5 minutes.

### (5) Lubricity

A nitrile rubber glove was dipped in the coating solution, and dried at 120° C. for 1 minute to prepare a test rubber glove. The grove was evaluated by the following criteria:
◯: the glove could be easily put on and off with no powder falling and with high lubricity
Δ: slightly inferior lubricity with some difficulty in putting on and off the gloves
×: poor lubricity with difficulty in putting on and off the gloves

TABLE 2

| | | | Example | | | | | | | | | |
|---|---|---|---|---|---|---|---|---|---|---|---|---|
| (parts by weight) | | | 1 | 2 | 3 | 4 | 5 | 6 | 7 | 8 | 9 | 10 |
| Composition | M-1 | | 2 | | | 0.1 | 5 | | | | | |
| | M-2 | | | 2 | | | | | | | | |
| | M-3 | | | | 2 | | | | | | | |
| | M-4 | | | | | | | 2 | | | | |
| | M-5 | | | | | | | | 2 | | | |
| | M-6 | | | | | | | | | 2 | | |
| | M-13 | | | | | | | | | | 2 | |
| | M-14 | | | | | | | | | | | 2 |
| | Polyurethane solution | | 98 | 98 | 98 | 99.9 | 95 | 98 | 98 | 98 | 98 | 98 |
| | Ion exchange water | | 1,500 | 1,500 | 1,500 | 1,500 | 1,500 | 1,500 | 1,500 | 1,500 | 1,500 | 1,500 |
| Coating thickness after drying (μm) | | | 20 | 20 | 20 | 20 | 20 | 20 | 20 | 20 | 20 | 20 |
| Physical property | Coating conditions | | ◯ | ◯ | ◯ | ◯ | ◯ | ◯ | ◯ | ◯ | ◯ | ◯ |
| | Static surface tension (mN/m) | | 25 | 25 | 25 | 30 | 20 | 25 | 25 | 25 | 26 | 25 |
| | Contact angle (°) | | 47 | 49 | 48 | 55 | 10 | 46 | 48 | 47 | 48 | 47 |
| | Foaming (ml) | immediately | 11 | 10 | 5 | 4 | 12 | 10 | 9 | 4 | 4 | 10 |
| | | after the coating | | | | | | | | | | |
| | | after 5 min | 5 | 0 | 0 | 0 | 6 | 4 | 0 | 0 | 0 | 4 |

| | | | | | | | | | | |
|---|---|---|---|---|---|---|---|---|---|---|
| Lubricity | ◯ | ◯ | ◯ | ◯ | ◯ | ◯ | ◯ | ◯ | ◯ | ◯ |

TABLE 3

| | | | Comparative Example | | | | | | |
|---|---|---|---|---|---|---|---|---|---|
| (parts by weight) | | | 1 | 2 | 3 | 4 | 5 | 6 | 7 |
| Composition | M-7 | | | 2 | | | | | |
| | M-8 | | | | 2 | | | | |
| | M-9 | | | | | 2 | | | |
| | M-10 | | | | | | 2 | | |
| | M-11 | | | | | | | 2 | |
| | M-12 | | | | | | | | 2 |
| | Polyurethane solution | | 100 | 98 | 98 | 98 | 98 | 98 | 98 |
| | Ion exchange water | | 1,500 | 1,500 | 1,500 | 1,500 | 1,500 | 1,500 | 1,500 |
| Coating thickness after drying (μm) | | | 20 | 20 | 20 | 20 | 20 | 20 | 20 |
| Physical property | Coating conditions | | X | Δ | Δ | Δ | Δ | Δ | Δ |
| | Static surface tension (mN/m) | | 40 | 26 | 26 | 28 | 26 | 29 | 26 |
| | Contact angle (°) | | 67 | 45 | 24 | 56 | 50 | 53 | 50 |
| | Foaming (ml) | immediately | 6 | 24 | 23 | 0 | 20 | 18 | 22 |
| | | after the coating | | | | | | | |
| | | after 5 min | 0 | 21 | 20 | 0 | 18 | 14 | 20 |

| | | | | | | | |
|---|---|---|---|---|---|---|---|
| Lubricity | X | Δ | Δ | Δ | Δ | Δ | Δ |

Japanese Patent Application No. 2011-226491 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A surfactant composition comprising
(A) an acetylenediol ethoxylate capped by a glycidyl ether represented by the following structural formula (I): 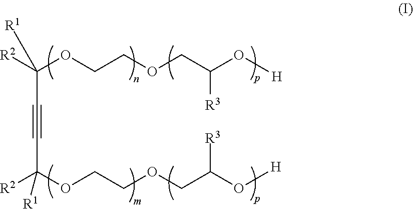
wherein R¹ is hydrogen atom, or a straight chain, branched or cyclic alkyl group containing 1 to 6 carbon atoms, R² is a straight chain, branched or cyclic alkyl group containing 1 to 12 carbon atoms, R³ is —CH₂OR⁴, R⁴ is a straight chain, branched or cyclic alkyl group, alkenyl group, aryl group, or aralkyl group containing 2 to 30 carbon atoms, n, m, p, and q are independently a positive number with the average of (n+m) being 1 to 100, and the average of (p+q) being 0.5 to 5, and
(B) a silicone surfactant.

2. A surfactant composition according to claim 1 which is used as a coating composition for a rubber article.

3. A surfactant composition according to claim 1 which comprises 5 to 80% by weight of component (A) and 20 to 95% by weight of component (B).

4. A surfactant composition according to claim 1 wherein the glycidyl ether of the component (A) is at least one member selected from 2-ethylhexyl glycidyl ether and lauryl glycidyl ether.

5. A surfactant composition according to claim 1 wherein the silicone surfactant of the component (B) is a nonionic silicone surfactant.

6. A surfactant composition according to claim 5 wherein the nonionic silicone surfactant is a polyoxyalkylene-modified silicone.

7. A surfactant composition according to claim 6 wherein the polyoxyalkylene-modified silicone is represented by the following average compositional formula (II):
R⁵ₓR⁶_{y}SiO_{(4-x-y)/2} (II)
wherein R⁵ is a substituted or unsubstituted monovalent hydrocarbon group containing 1 to 10 carbon atoms and having no aliphatic unsaturated bond; R⁶ is an organic group represented by —C_{f}H_{2f}O(C_{g}H_{2g}Oₕ)R⁷ wherein R⁷ is hydrogen atom, a substituted or unsubstituted monovalent hydrocarbon group having no aliphatic unsaturated group, or an acetyl group, f is an integer of 2 to 12, g is an integer of 2 to 4, and h is an integer of 1 to 200; and x and y are independently a positive number satisfying 0≦x<3.0, 0<y<3.0, and 0<x+y≦3.0.

8. A surfactant composition according to claim 6 wherein content of the polyoxyethylene in the polyoxyalkylene-modified silicone is in the range of 30 to 80% by weight.

9. A surfactant composition according to claim 1 further comprising
(C) an ion exchanged water or a water-soluble organic solvent at an amount of up to 90 parts by weight in relation to 100 parts by weight of the total of the component (A) and the component (B).

10. A coating solution containing the surfactant composition of claim 1 and a synthetic resin.

11. A coating solution according to claim 10 wherein the synthetic resin has a weight average molecular weight in terms of polystyrene as measured by gel permeation chromatography (GPC) of 2,000 to 500,000, and is at least one selected from the group consisting of polyvinyl alcohol, oxidized starch, etherified starch, carboxymethylcellulose, hydroxyethylcellulose, casein, gelatin, soy protein, silanol-modified polyvinyl alcohol, latex of styrene-butadiene copolymer and methylmethacrylate-butadiene copolymer, latex of acrylate and methacrylate copolymer, maleic anhydride resin, melamine resin, urea resin, polymethylmethacrylate, polyurethane, unsaturated polyester, polyvinylbutyral, and alkyd resin.

12. A coating solution according to claim 10 which has a static surface tension of 20 to 32 mN/m.

13. A rubber article having a coating film formed by using the coating solution of claim 9.

14. A rubber article according to claim 13 which is used as a home, toy, sport or farm implement.

15. A rubber article according to claim 13 which is a surgical glove, inspection glove, work glove, contraceptive, catheter, balloon, tube or sheet.

16. A rubber article according to claim 13 wherein a thickness of the rubber obtained from the coating solution of claim 10 is 0.5 to 300 μm at the dry state.

17. A method of preparing a rubber article comprising applying the coating solution of claim 10 to a rubber selected from the group consisting of nitrile rubber, chloroprene rubber, ethylene propylene rubber, butyl rubber, urethane rubber, styrene butadiene rubber, butadiene rubber, isoprene rubber, acrylic rubber, carboxy-modified acrylic rubber, fluororubber, and silicone rubber, and drying the coating solution at normal temperature to 150° C. for 0.5 to 5 minutes to form a film having a thickness of 0.5 to 300 μm at the dry state.
